(19) United States
(12) Patent Application Publication
(10) Pub. No.: US 2008/0014797 A1
(43) Pub. Date: Jan. 17, 2008

(54) Electrical connector with reliable shielding member

(75) Inventor: Meng-Huan Yang, Tu-Chun (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/827,408

(22) Filed: Jul. 11, 2007

(30) Foreign Application Priority Data
Jul. 11, 2006 (CN) 200620074874.2

(51) Int. Cl. H01R 13/648

(52) U.S. Cl. 439/607

(57) ABSTRACT

An electrical connector (100) comprises an insulative housing (1) defining an upper receiving cavity (13) for receiving a camera module (200) therein, a plurality of terminals (2) received in the housing, and a first and a second shielding members (3, 4) cooperative for enclosing the housing. Each terminal has a retaining portion (21) secured in the housing and a contact portion (22) extending into the receiving cavity for electrically engaging with the camera module. The first shielding member is assembled to the housing from a lower-to-upper direction for surrounding two opposite lateral sides (10, 11) of the housing and has a pair of opposite first walls (30) extending upwardly thereof. The first wall each defines a pair of retaining members (300), with S-shaped configuration, extending inwardly for reliably engaging with the camera module. The second shielding member is assembled to the housing from an upper-to-lower direction for surrounding the housing.

### BACKGROUND OF THE INVENTION

1. Field of the invention

The present invention relates to an electrical connector, and more particularly to an electrical connector used for electrically interconnecting a camera module with a substrate such as a printed circuit board (PCB).

2. Description of the prior art

Due to the development of the information and communication technology industry, various types of portable wireless terminals such as mobile phones, Personal Digital Assistant always simply called as PDA and so forth. Said terminals are provided with various functions, for example, e-mail reception and transmission, Internet games and text transmission. Beyond the above basic functions, recently, image communication as a new function is introduced. As a result, said various portable wireless terminals are additionally provided with camera module, correspondingly, electrical connectors are used for connecting with the camera modules are also provided and also disclosed in U.S. Patent Publication No. 2003/0218873.

Referring to FIGS. 6 and 7, a conventional electrical connector 100′ comprises a pair of longitudinally insulative housings 1′, a plurality of terminals 2′ received in the housing 1′, a pair of metal covers 4′ respectively covering onto the corresponding housing 1′, a shield 3′ engaged with the housing 1′ for receiving a camera module (not shown) therein. The shield 3′ comprises a pair of opposite first walls 31′, a pair of opposite second walls 32′ engaged with the housing 1′, and a bottom wall 33′ connecting with the first and second walls 31′, 32′ for cooperation defining a cavity 34′ to receive the camera module therein, of which the shield 3′ surfacely and peripherally surrounds the camera module. A pair of resilient arms 315′ extends toward to the cavity 34′ from an upper portion of the first wall 31′ to catch the camera module and fasten the camera module in the cavity 34′ of the shield 3′, thereby electrical connection between the terminals 2′ and the camera module is obtained.

However, a fastening structure for fastening the camera module in the connector is provided only the resilient arms 315′ of the connector 100′. The resilient arms 315′ are not substantially firm because it is flexible and easy to deform, and thus the camera module is likely to drop out of the connector 100′ due to outer shock, or the like. Furthermore, when the resilient arm 315′ is on reformation state for a long time, its flexibility will be reduced, thereby the fastness between the camera module and the connector 100′ is minimized. Additionally, a corresponding portion of the resilient arm 315′ engaged with the camera module is relative to harsh when the camera module inserts into the cavity 34′ or detaches from the cavity 34′ again and again, the portion of the resilient arm 315′ is easy to scrape the camera module. Moreover, the conventional connector 100′ can not achieve desired Electro-Magnet Interference suppression because the shield 3′ and the cover 4′ can not substantially enclose the camera module after the camera module electrically connects with the terminals 2′ of the connector 100′.

Thus, there is a need to provide a new electrical connector that overcomes the above-mentioned problems.

### SUMMARY OF THE INVENTION

Accordingly, an object of the present invention is to provide an electrical connector used for connecting with a camera module, which has shielding members, wherein the shielding member is configured to securely and reliably receive the camera module therein.

Accordingly, another object of the present invention is to provide an electrical connector adapted for securely receiving a camera module therein, the connector is well shielded for suppressing Electro-Magnetic Interference.

To fulfill the above-mentioned object, an electrical connector in accordance with a preferred embodiment of the present invention comprises an insulative housing defining an upper receiving cavity for receiving a camera module therein, a plurality of terminals received in the housing, and a first and second shielding members cooperation for substantially enclosing the housing. Each terminal has a retaining portion secured in the housing and a contact portion extending into the receiving cavity of the housing for electrically engaging with the camera module. The first shielding member is assembled to the housing from a lower-to-upper direction for surrounding two opposite substantial sidewalls of the receiving cavity of the housing. The first shielding member has a pair of opposite first walls extending upwardly thereof. The first wall each defines a pair of retaining members, with S-shaped configuration, extending inwardly for reliably engaging with the camera module. The second shielding member is assembled to the housing from an upper-to-lower direction for surrounding a substantial upper side of the receiving cavity of the housing.

Other objects, advantages and novel features of the present invention will become more apparent from the following detailed description when taken in conjunction with the accompanying drawings, in which:

### BRIEF DESCRIPTION OF THE DRAWINGS

FIG. 1 is an exploded, isometric view of an electrical connector in accordance with a preferred embodiment of the present invention;

FIG. 2 is a partially assembly view of FIG. 1, but showing terminals engaged with a housing of the electrical connector;

FIG. 3 is a partially assembly view of FIG. 2, but showing a shield engaged with the terminals and the housing;

FIG. 4 is an assembly view of FIG. 1, showing a camera module engaged with the connector;

FIG. 5 is similar to FIG. 4, but showing the connector inverted;

FIG. 6 is an exploded, isometric view of a conventional connector; and

FIG. 7 is an assembly view of FIG. 6.

### DESCRIPTION OF PREFERRED EMBODIMENT OF THE INVENTION

Reference will now be made to the drawings to describe the present invention in detail.

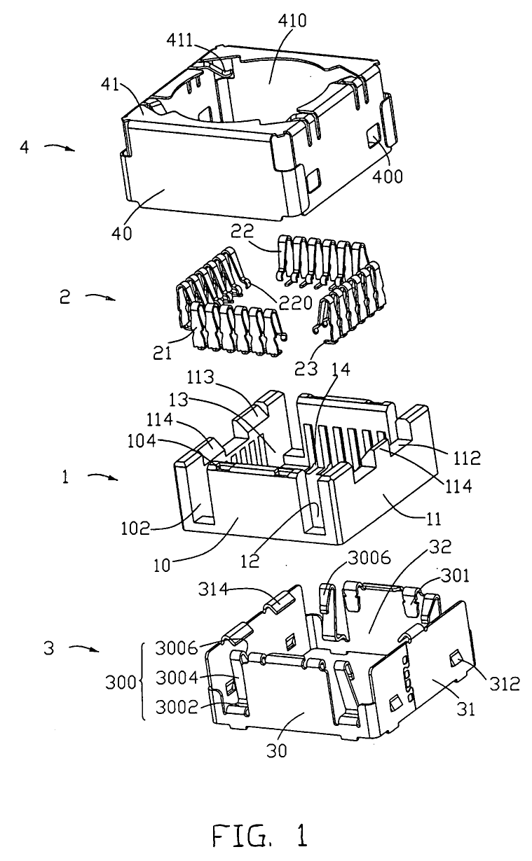

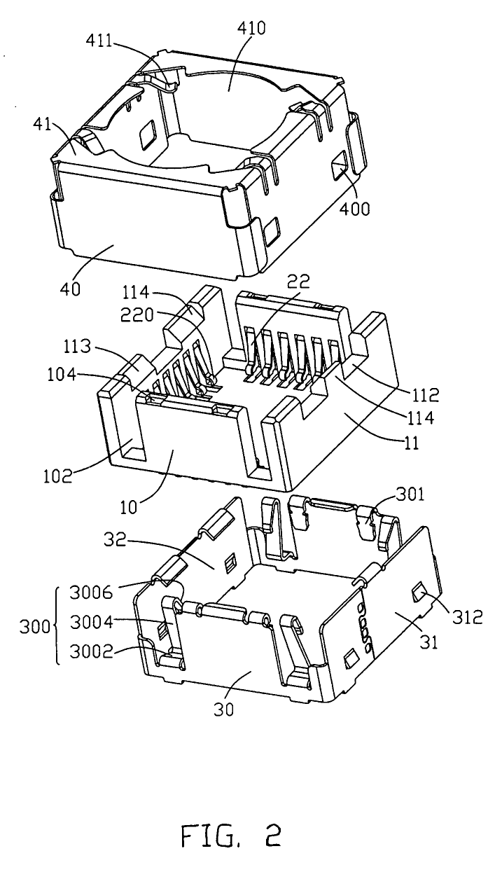

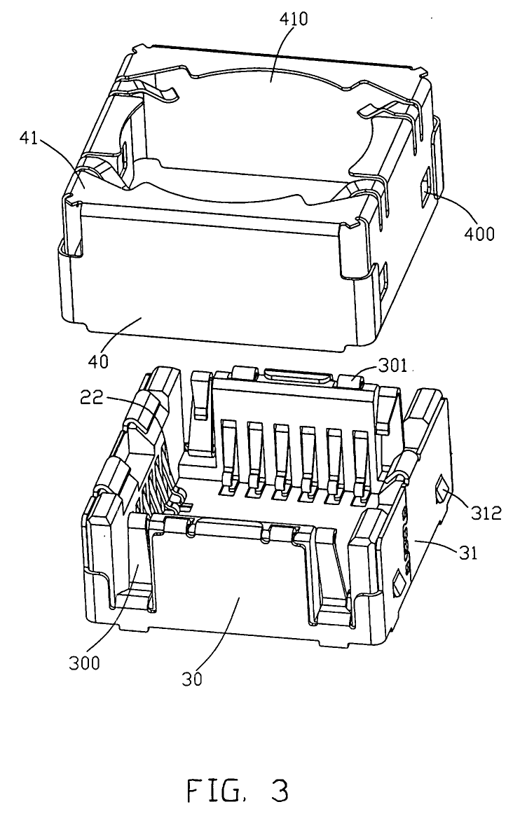

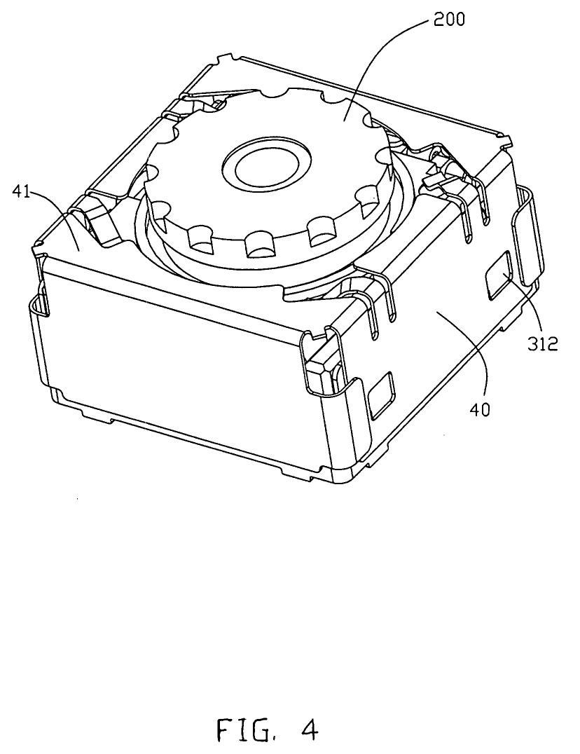

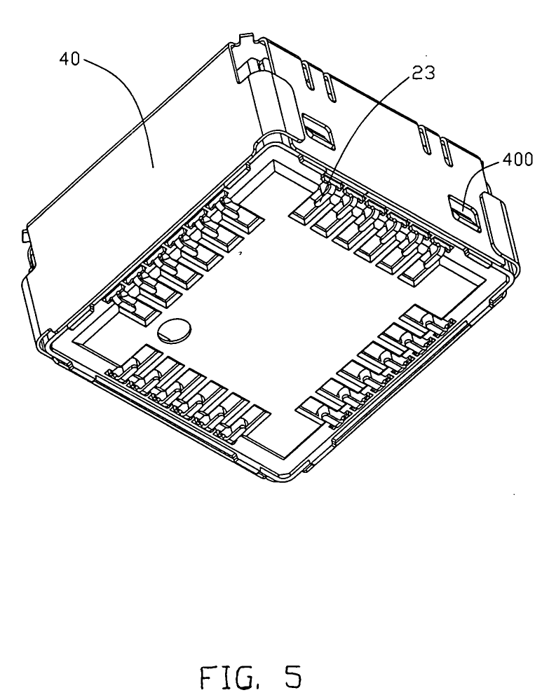

Referring to FIGS. 1-5, an electrical connector 100 in accordance with the preferred embodiment of the present invention is provided for electrically connecting a camera module 200 (seen FIG. 4) with a printed circuit board (not shown). The connector 100 comprises a generally rectangular insulative housing l, and a multiplicity of terminals 2 received in the housing 1, a first shielding member 3 and a second shielding member 4 cooperative to substantially enclose the housing 1.

The housing 1 comprises a pair of opposite first sidewalls 10, a pair of opposite second sidewalls 11 connecting with the first sidewall 10, and a bottom wall 12 connecting with the first and second sidewalls 10, 11. The first and second sidewalls 10, 11 and the bottom wall 12 are cooperative to provide an upper receiving cavity 13 for receiving the camera module 200 therein. A plurality of passageways 14 respectively extends from the first and second sidewalls 10, 11 through the bottom wall 12 to form an L-shaped configuration for receiving corresponding terminals 2 therein. The passageway 14 defines a vertical portion (not labeled) formed in the first and second sidewalls 10, 11 and a horizontal portion (not labeled) formed through the bottom wall 12. The first sidewall 10 defines a pair of recesses 102 at opposite ends adjacent to the respective second sidewalls 11 and a pair of slots 104 formed on an upper portion thereof. One of the second sidewalls 11 defines a protrusion 114 formed on a middle portion thereof and a pair of gaps 112 formed at opposite ends of the protrusion 114. The other second sidewall 11 defines a pair of protrusions 114 corresponding to the gaps 112 of the one sidewall 11 and a gap 112 corresponding to the protrusion 114 of the one sidewall 11. The protrusion 114 defines a slant surface 113 on an upper portion thereof for guiding the camera module 200 to insert into the receiving cavity 13.

The terminal 2 comprises a base portion 21 received in the vertical portion of the passageway 14, a spring arm 22 extending slantly outward from one end of the base portion 21 to form an acute angle between the spring arm 22 and the base portion 21, and a soldering portion 23 extending horizontally from the other end of the base portion 21 and received in the horizontal portion of the passageway 14. The spring arm 22 defines a contact portion 220 at a distal end thereof for electrically connecting with the camera module 200.

The first shielding member 3 is integrally formed by bending a punched metal plate and comprises a pair of first walls 30 for enclosing corresponding first sidewall 10 of the housing 1, and a pair of second walls 31 for enclosing corresponding second sidewall 11 of the housing 1. The first walls 30 and the second walls 31 are cooperative to form an opening 32 for enclosing the housing I from an lower-to-upper direction. Each first wall 30 defines a pair of L-shaped retaining tabs 301 formed on an upper portion thereof to engage with corresponding slots 104 of the housing 1, and a pair of S-shaped retaining members 300 extending slantly upwardly and inwardly to the receiving cavity 13 of the housing I from a lower portion thereof so as to receive in corresponding recess 102 of the housing 1. The retaining member 300 comprises a connecting portion 3002 extending horizontally toward to the opening 32 from the lower portion of the first wall 30, a spring portion 3004 extending vertically and upwardly from one end of the connecting portion 3002, and a resilient tab 3006 extending downwardly from an upper portion of the spring portion 3004. The resilient tab 3006 defines a gyroidally smooth portion (not labeled) at a distal end thereof. One of the second walls 31 defines a pair of slices 314 bending into the opening 32 from an upper portion thereof, while the other second wall 31 defines only one slice 34, whereby engaging with corresponding projections 114 of the housing 1. The second wall 31 also defines a pair of hooks 312 extending outwardly from a lower portion thereof.

The second shielding member 4 includes a top plate 41 and a plurality of securing pieces 40 depending downwardly from the top plate 41. The top plate 41 defines a receiving opening 410 in a middle portion thereof, and a plurality of stamped ribs 411 protruding downwardly at corners of the receiving opening 410. Each of opposite securing pieces 40 defines a pair of holes 400 thereof for engaging with corresponding hook 312 of the first shielding member 3.

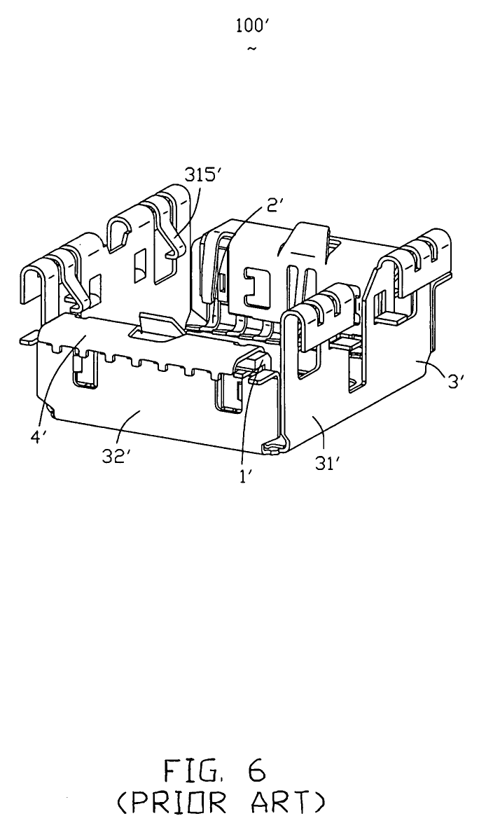

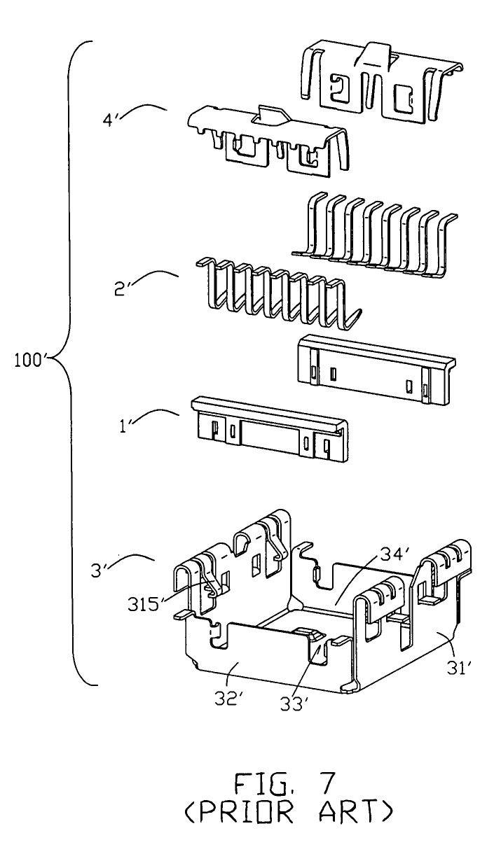

In assembly, referring to FIGS. 4-7, the terminals 2 are firstly assembled to the housing I from a bottom surface of the housing 1. The base portion 21 is interferentially received in the vertical portion of the L-shaped passageway 14, the spring arm 22 extending into the receiving cavity 13 and the soldering portion 23 extending outwardly out of the bottom wall 12 of the housing 1 to be soldered to the PCB thereby securing the terminals 2 in the housing 1. Following, the first shielding member 3 is attached to the housing 1 from the bottom surface of the housing 1. The retaining tabs 301 are pressed into the slots 104 of the housing 1 and interferentially engaged with the housing 1, and the slice 314 engaged with the corresponding projection 114 and the retaining member 300 received in the recess 102, whereby the first and second walls 30, 31 of the first shielding member 3 surrounding outer peripheral of the housing 1. Secondly, the camera module 200 is disposed in the receiving cavity 13 of the housing 1, the retaining member 300 of the first shielding member 3 and the spring arm 22 of the terminal 2 will deform to respectively engage with corresponding side and pad of the camera module 200 to electrically engage with the contact portion 220 of the terminal 2 via pressing against the spring arm 22 of the terminal 2. At this state, the smoothly resilient tab 3006 of the retaining member 300 is touched onto corresponding side of the camera module 200 to secure the camera module 200 in the receiving cavity 13 of the housing 1 so as to prevent the retaining member 300 from scraping the sides of the camera module 200. Lastly, the second shielding member 4 is displaced over the housing 1 from an upper-to-lower direction. An upper portion (not labeled) of the camera module 200 extends out of the circular opening 410; the securing pieces 40 abut against outer surfaces of the first shielding member 3 with the hooks 312 engaging with the holes 400; the ribs 411 abut against an upper surface of the camera module 200, whereby a secured and well electromagnetic suppressed camera connector module and the electrical connection between the camera module 200 and the connector 100 are obtained.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical connector adapted for receiving a camera module therein, comprising:
an insulative housing defining four sidewalls, a bottom wall and a cavity for receiving the camera module, one pair of opposite sidewalls of the four sidewalls each defining a pair of recesses at opposite ends thereof adjacent to the other pair of sidewalls and a pair of slots on an upper portion thereof;
a plurality of terminals received in the insulative housing, each terminal having a base portion secured in the sidewall of the housing and a contact portion extending into the cavity of the housing for electrically engaging with the camera module;
a first shielding member assembled to the housing from a top-to-bottom direction for substantially surrounding the sidewalls of the housing, the first shielding member having at least one resilient retaining member extending upwardly through the recess into the cavity of the housing, and at least a pair of retentive tabs secured to the slots; and
a second shielding member assembled to the housing from the top-to-bottom direction for substantially surrounding the sidewalls of the housing, the second shielding member being locked with the first shielding member; and
wherein the retaining member is capable of resiliently engaging with corresponding side of the camera module.

2. The electrical connector according to claim 1, wherein the first shielding member is integrally formed by bending a punched metal plate and comprises a pair of first walls, a pair of second walls connecting the first walls and an opening formed between the first and second walls.

3. The electrical connector according to claim 2, wherein the retaining member is S-shaped and extends upwardly from a lower portion of the first wall.

4. The electrical connector according to claim 3, wherein the retaining member comprises a connecting portion extending horizontally toward the opening from the lower portion of the first wall, a spring portion extending vertically and upwardly from one end of the connecting portion, and a resilient tab extending downwardly from an upper portion of the spring portion, the resilient tab defining a curved portion at a distal end thereof.

5. The electrical connector according to claim 2, wherein the second wall defines at least one slice bent into the opening from an upper portion thereof and a pair of hooks extending outwardly from a lower portion thereof.

6. The electrical connector according to claim 5, wherein the second shielding has a top plate and at least a pair of retaining pieces extending downwardly from the top plate.

7. The electrical connector according to claim 6, wherein the retaining pieces of the second shielding define holes for engaging with the hooks of the first shielding member.

8. The electrical connector according to claim 6, wherein the top plate defines a receiving opening in a middle portion thereof, and a plurality of stamped ribs protruding downwardly at corners of the receiving opening.

9. The electrical connector according to claim 1, wherein a plurality of passageways extends from the sidewalls and through the bottom wall to form a L-shaped configuration for receiving corresponding terminals therein, the passageway defining a vertical portion formed in the sidewalls and a horizontal portion formed through the bottom wall.

10. The electrical connector according to claim 9, wherein the base portion of the terminal is received in a vertical portion of the passageway, a spring arm extending slantly outward from one end of the base portion to form an acute angle between the spring arm and the base portion, and the soldering portion extends horizontally from the other end of the base portion.

11. An electrical connector adapted for receiving an electronic element therein, comprising:
an insulative housing defining an upper cavity for receiving an electronic element therein;
a plurality of terminals received in the insulative housing, each terminal having a retaining portion secured in the housing and a contact portion extending into the cavity of the housing for electrically engaging with the electronic element;
a first shell member securely assembled to the housing in substantially a completely circumferentially horizontally enclosing manner; and
a second shell member securely assembled to at least one of the housing and the first shell and covering substantially an upper side of the cavity of the housing; wherein
said second shell includes a plurality of spring tangs arranged in a circumferential manner and extending downwardly into the cavity for abutting against the electronic element.

12. The connector as claimed in claim 11, wherein said second shell includes a top plate from which the spring tangs extend.

13. The connector as claimed in claim 11, wherein said second shell includes a top plate defining an opening for upward extension of the electronic element.

14. The connector as claimed in claim 11, wherein said second shell includes a top plate which defines an opening for upward extension of the electronic element and which the spring tangs extends from.

15. An electrical connector for use with an electronic module, comprising:
an insulative housing defining a receiving cavity surrounded by a plurality of side walls;
a plurality of contacts disposed in the housing with contacting sections extending into the receiving cavity;
a first metallic shell assembled to the housing and including a laterally deflectable retaining member for engaging a lateral side of the electronic module;
a second metallic shell assembled to the first shell and including an upwardly
deflectable rib for downwardly pressing an upper face of the electronic module.

16. The electrical connector as claimed in claim 15, wherein said housing defines a recess in one of the side walls, through which the retaining member outwardly moves.
